(19) United States
(12) Patent Application Publication
(10) Pub. No.: US 2020/0272041 A1
(43) Pub. Date: Aug. 27, 2020

(54) ACTUATOR MODULE AND PROJECTOR HAVING THE SAME

(71) Applicant: Qisda Corporation, Taoyuan City (TW)

(72) Inventors: PO-FU WU, New Taipei City (TW); YI-HAO CHEN, Tainan City (TW)

(73) Assignee: Qisda Corporation, Taoyuan City (TW)

(21) Appl. No.: 16/784,823

(22) Filed: Feb. 7, 2020

(30) Foreign Application Priority Data
Feb. 21, 2019 (CN) 201910129450.3

(51) Int. Cl. G03B 21/22; G03B 21/14

(52) U.S. Cl. CPC G03B 21/22; G03B 21/142

(57) ABSTRACT

An actuator module and a projector having the same are provided. The actuator module includes an actuator including a frame and a lens movably disposed on the frame, and a pair of weighted blocks disposed on the frame and located at two opposite sides of the lens.

### BACKGROUND OF THE INVENTION

### 1. Field of the Invention

The invention generally relates to an actuator module. Particularly, the invention relates to an actuator module with a noise reduction design and a projector having the same.

### 2. Description of the Prior Art

At present, the display principle of 4K ultra-high-definition (4K UHD) projectors is to use an extended pixel resolution actuator (XPR), such as electromagnets, to make the optical components shift to two or four positions, so that the resolution can be improved. However, the continuous movement (or operation) of the actuator causes the leakage of vibration energy, and abnormal sounds (or noises) are generated due to the leaked vibration energy, which causes considerable distress to the user. In addition, when the actuator is integrated to the optical engine housing inside the projector into a modular form, noises generated as the actuator operates are amplified and become louder due to the speaker effect of the optical engine housing, further seriously affecting the operation quality of the projector.

### SUMMARY OF THE INVENTION

It is an object of the invention to provide an actuator module, which is provided with weighted blocks to reduce vibrations during operation to achieve the noise reduction effect.

In an embodiment, the invention provides an actuator module for a projector. The actuator module includes an actuator and a pair of weighted blocks, wherein the actuator includes a frame and a lens movably disposed on the frame, and the pair of weighted blocks are disposed on the frame and located at two opposite sides of the lens.

In an embodiment, the actuator module further includes a clamp member engaging with the frame to sandwich the pair of weighted blocks between the clamp member and the frame.

In an embodiment, the clamp member has a pressing portion corresponding to the pair of weighted blocks and extending toward the frame to press the pair of weighted blocks against the frame.

In an embodiment, the pair of weighted blocks are adhered to the frame.

In an embodiment, the weight of the pair of weighted blocks is 7.5% to 15% of the weight of the actuator.

In another embodiment, the invention provides a projector including the actuator module described above and an image-forming component, wherein the image-forming component is configured to generate an image light, and the actuator module is disposed corresponding to the image-forming component and configured to guide the image light to a first location or a second location.

In another embodiment, the projector of the invention includes a projector housing, an image-forming component, an optical engine module, a light modulation unit, an actuator, a pair of weighted blocks, and a light source, wherein the projector housing has a first light outlet; the image-forming component is disposed in the projector housing; the optical engine housing is disposed in the projector housing; the optical engine housing has a second light outlet and a light inlet; the light modulation unit is disposed in the projector housing; the actuator is disposed in the optical engine housing; the actuator includes a frame and a lens movably disposed on the frame; the pair of weighted blocks are disposed on the frame and located at two opposite sides of the lens; the light source is disposed in the projector housing and configured to generate a first light incident to the light modulation unit and reflected by the image-forming component to form a first image light, wherein the first image light enters the optical engine housing from the light inlet to form a second image light by the actuator, and the second image light exits the optical engine housing from the second light outlet and emits out of the projector housing from the first light outlet.

In an embodiment, the lens is movable relative to the frame to have a first inclined angle or a second inclined angle with respect to the frame, so as to guide the image light to the first location or the second location.

Compared to the prior art, the actuator module and the projector of the invention utilizing the design of weighted blocks can reduce vibrations of the actuator in operation, and further reduce noises generated as the actuator operates to achieve the noise reduction effect.

### BRIEF DESCRIPTION OF THE DRAWINGS

FIGS. 1A and 1B are exploded views of an embodiment of the actuator module of the invention from different viewing angles.

FIG. 2 is a schematic view of the actuator module in an embodiment of the invention.

FIGS. 3A to 3D are schematic views showing operations of the actuator module in an embodiment of the invention.

FIG. 4 is a schematic view of the actuator module in another embodiment of the invention.

FIGS. 5A and 5B are schematic views of the actuator module of FIG. 4 from different viewing angles.

FIG. 6 is a schematic view of the projector in an embodiment of the invention.

FIG. 7 is a schematic view of the projector in another embodiment of the invention.

### DETAILED DESCRIPTION OF THE PREFERRED EMBODIMENT

The invention provides an actuator module, particularly an actuator module which reduces noises generated by operation vibrations through weighted blocks. The actuator module of the invention can be applied to a projecting device, and thus the invention further provides a projector having the actuator module to reduce noises and improve operation quality. Hereinafter, embodiments of the actuator module and the projector of the invention will be described in detail with reference to the drawings.

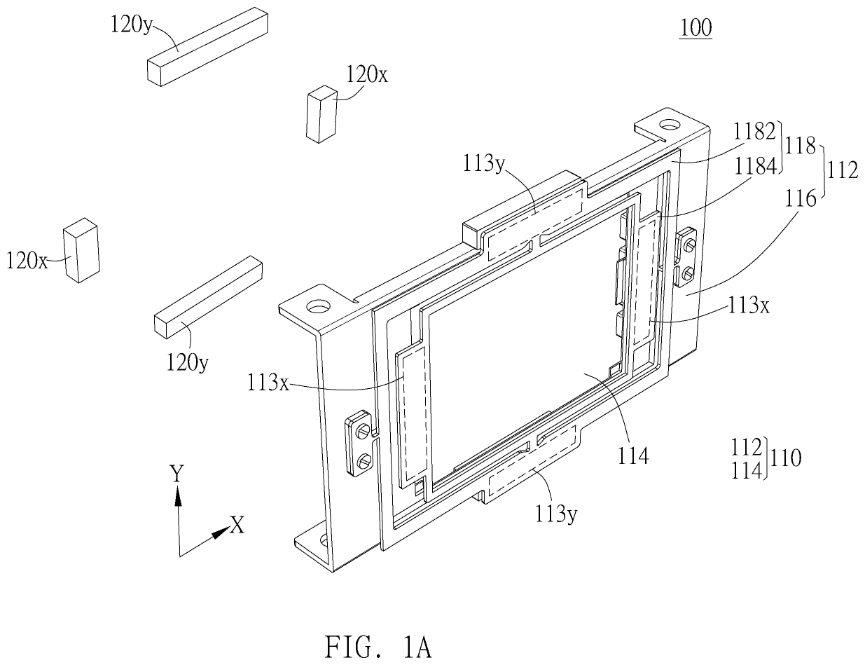

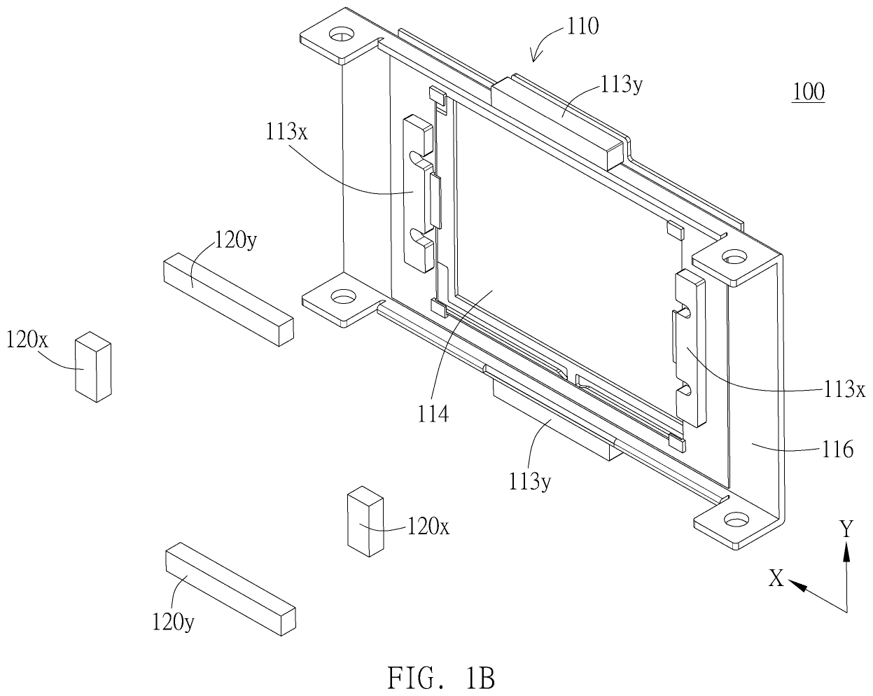

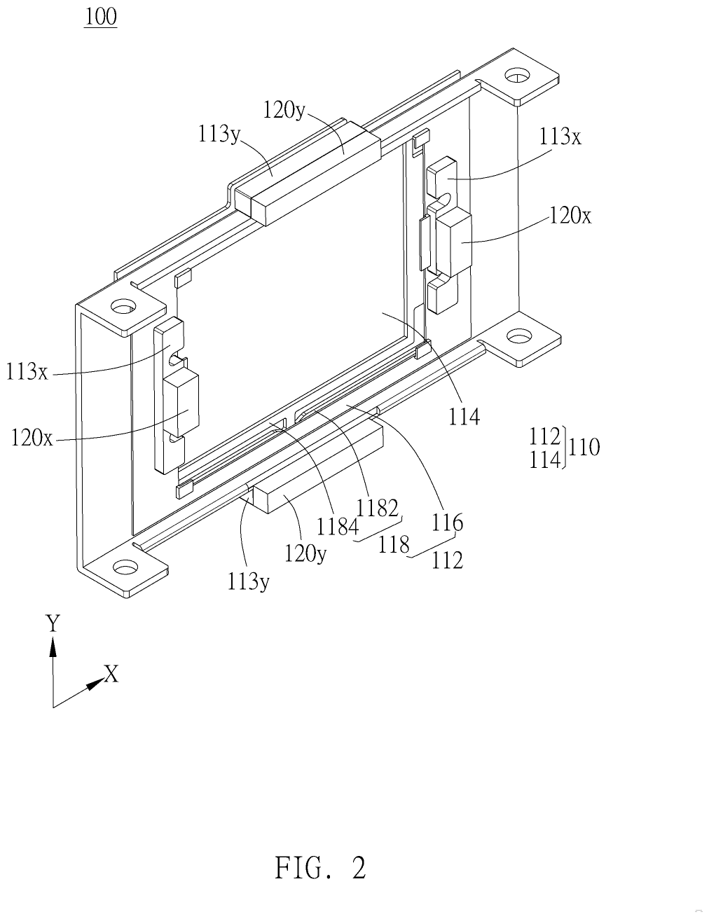

As shown in FIGS. 1A, 1B and 2, in an embodiment, the actuator module 100 includes an actuator 110 and weighted blocks, such as 102x, 120y. The actuator 110 includes a frame 112 and a lens 114. The lens 114 is movably disposed on the frame 112. The actuator 110 can be disposed on a buffering material (not shown), such as a spring, but not limited thereto. The weighted blocks (e.g. 120x, 120y) are preferably disposed in pair on the frame 112 and located at two opposite sides of the lens 114. The lens 114 is movably relative to the frame 112 to change the inclined angle of the lens 114 with respect to the frame 112, so that light incident on the lens 114 can be guided to different locations (or optical paths). For example, the frame 112 may include a frame body 116 and a lens carrier 118. The frame body 116 is provided with a driving mechanism, which is configured to drive the lens 114 to move relative to the frame body 116 and changes the inclined angle of the lens 114 with respect to the frame body 116. In an embodiment, the driving mechanism can be embodied as electromagnets, such as 113x, 113y. The lens carrier 118 is partially connected to the frame body 116, so that by controlling the driving mechanism, the lens carrier 118 can move (or deform) in one dimension or two dimensions, such as X axis direction, Y axis direction, or both X axis and Y axis directions, with respect to the frame body 116, to change the inclined angle of the lens 114 with respect to the frame body 116.

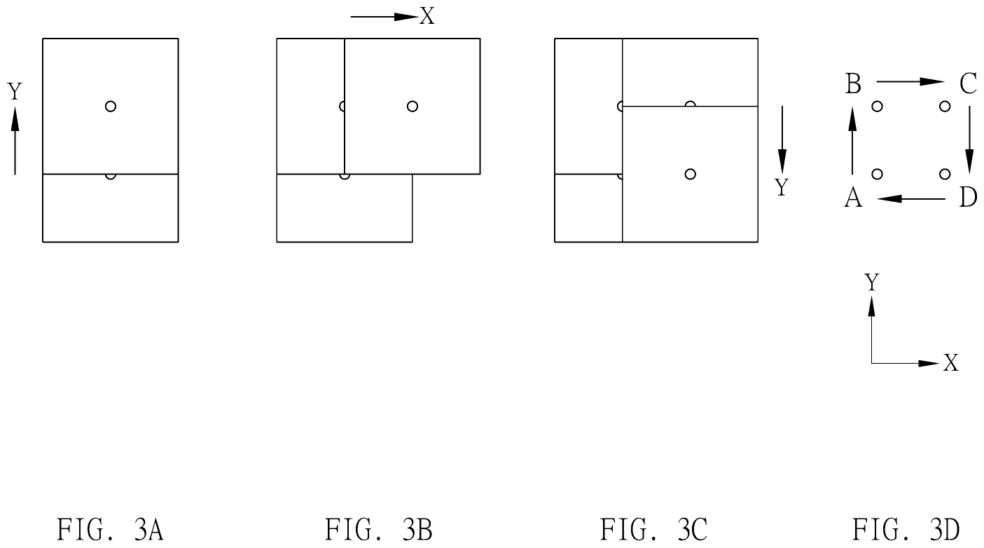

In this embodiment, the lens carrier 118 is preferably in form of two frames, so that the lens 114 can move relative to the frame body 116 in the X axis direction and the Y axis direction to change the inclined angle of the lens 114 with respect to the frame body 116. For example, the lens carrier 118 includes an outer frame 1182 and an inner frame 1184, wherein the outer frame 1182 is partially connected to the frame body 116 at two sides along the X axis direction, while the inner frame 1184 is disposed at the inner side of the outer frame 1182 and partially connected to the outer frame 1182 at two sides along the Y axis direction. The lens 114 is disposed on the inner frame 1184. Two sets of electromagnets 113x, 113y are disposed on the frame body 116 at two opposite sides of the X axis direction and the Y axis direction corresponding to the locations where the outer frame 1182 and the frame body 116 are partially connected and where the inner frame 1184 and the outer frame 1182 are partially connected. As shown in FIGS. 3A to 3D, by controlling the electromagnets 113x, 113y, the outer frame 1182 and/or the inner frame 1184 is enabled to rotate (or deform) with respect to the frame body 116, so that the lens 114 can have different inclined angles with respect to the frame body 116 to project the light, which is incident onto the lens 114, to four different locations A, B, C, D in two dimensions, such as X axis direction and Y axis direction.

In this embodiment, two pairs of weighted blocks 120x, 120y are disposed on the frame 112 around the lens 114. For example, one pair of weighted blocks 120x are disposed on the frame body 116 along the X axis direction and located at two opposite sides of the lens 114 in the X axis direction, such as left and right sides; the other pair of weighted blocks 120y are disposed on the frame body 116 along the Y axis direction and located at two opposite sides of the lens 114 in the Y axis direction, such as upper and lower sides. In this embodiment, each pair of weighted blocks 120x, 120y are preferably disposed on the frame body 116 corresponding to the location of the electromagnets 113x, 113y. For example, the pair of weighted blocks 120x can be disposed on the electromagnet 113x, which is disposed along the X axis direction, while the other pair of weighted blocks 120y can be disposed on the electromagnets 113y, which is disposed along the Y axis direction, but not limited thereto. In this embodiment, two pairs of weighted blocked 102x, 120y are disposed in the X axis direction and the Y axis direction, respectively, but not limited thereto. In another embodiment (not shown), only one pair of weighted blocks may be disposed on the frame body 116 along the X axis direction or the Y axis direction and located at two opposite sides of the lens 114 in the X axis direction or the Y axis direction.

The weighted blocks 120x, 120y can be metal blocks having specific weight, such as lead blocks or copper blocks. In an embodiment, the weight of the weighted blocks 120x, 120y is preferably 7.5% to 15% of the weight of the actuator 110. For example, when one pair of weight blocks (or two pairs of weighted blocks) are disposed, the total weight of the weighted blocks is preferably 7.5% to 15% of the weight of the actuator 110, but not limited thereto. The number, the disposing locations, and the weight of the weighted blocks can be modified according to practical applications, not limited to the embodiment, to reduce vibrations induced when the actuator operates and in turn to reduce noises caused by the vibrations.

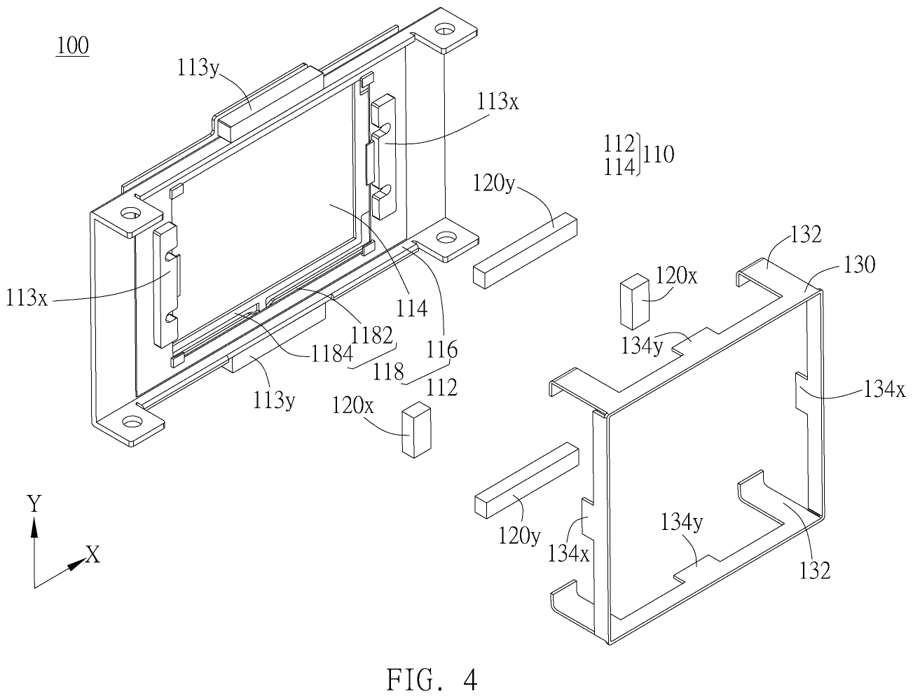

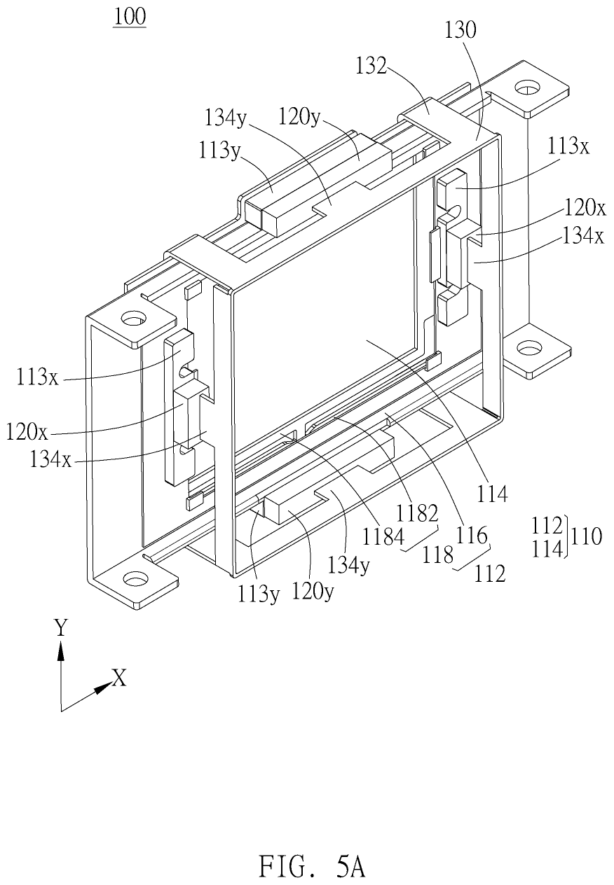

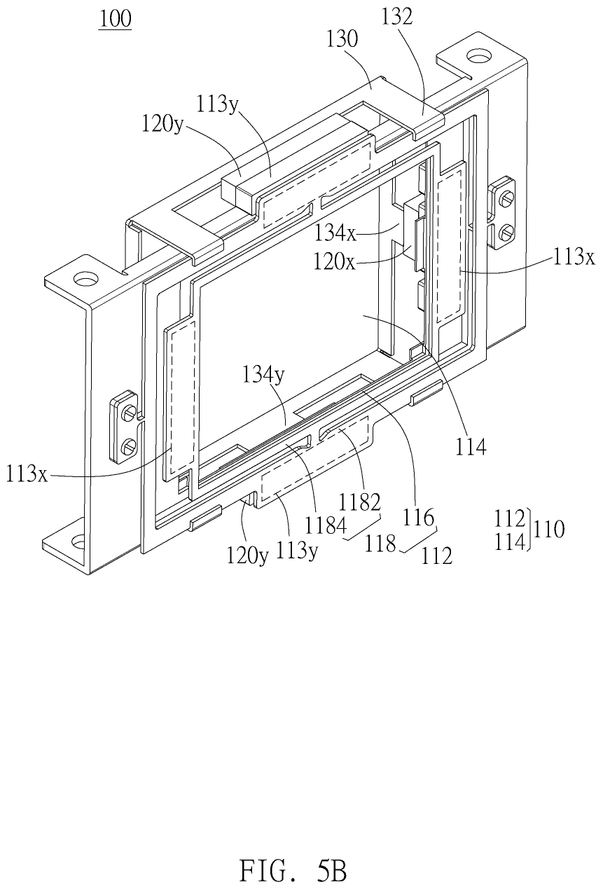

In an embodiment, the weighted blocks can be adhered to the frame by adhesives or adhesive tapes (single-sided tape or double-sided tape), but not limited thereto. In another embodiments, by modifying the design of the frame, the weighted blocks can be held on the frame, or the weighted blocks can be positioned on the frame by using other clamping means. As shown in FIG. 4 and FIGS. 5A and 5B, in another embodiment, the actuator module 100 further includes a clamp member 130. The clamp member 130 engages with the frame 112 to sandwich the weighted blocks, such as 120x, 120y, between the clamp member 130 and the frame 112. As shown in the figures, the clamp member 130 has an engaging portion 132 and a pressing portion, such as pressing portions 134x, 134y. The engaging portion 132 is configured to engage with the frame 112. The pressing portions 134x, 134y are configured to press the weighted blocks 120x, 120y against the frame 112. For example, the clamp member 130 can be a frame-like clamp member, and the engaging portion 132 can be hook-like structures disposed on the upper and lower sides of the clamp member 130 and protrudes toward the frame body 116. The pressing portions 134x, 134y are preferably disposed corresponding to the locations of the weighted blocks 120x, 120y disposed on the frame 112 and extend (or protrude) toward the frame 112 to press the weighted blocks 120x, 120y against the frame 112. As such, the weighted blocks 120x, 120y can be sandwiched between the frame 112 and the clamp member 130 to achieve the effect of positioning or holding the weighted blocks 120x, 120y on the frame 112. For example, four pressing portions 134x, 134y are disposed at four sides of the clamp member 130 and extend toward the same side as the engaging portion 132, i.e., toward the frame body 116, to correspond to the two pairs of weighted blocks 120x, 120y, respectively. When the clamp member 130 engages with the frame body 116 by means of the engaging portions 132, the four pressing portions 134x, 134y respectively press the four weighted blocks 120x, 120y against the electromagnets 113x, 113y on the frame 112, so as to position the weighted blocks 120x, 120y.

The clamp member 130 can be made from plastics by injection molding or metal plates by stamping or bending. When the weighted blocks 120x, 120y are positioned by the clamp member 130, the total weight of the weighted blocks 102x, 120y and the clamp member 130 is preferably 7.5% to 15% of the weight of the actuator 110, but not limited thereto. When the weighted blocks 120x, 120y are positioned by the clamp member 130, the number, the disposing locations, and the weight of the weighted blocks can be modified according to practical applications, not limited to the embodiment, to reduce vibrations induced when the actuator operates and in turn to reduce noises caused by the vibrations. In other words, when the weighted blocks 120x, 120y are positioned by the clamp member 130, the weighted blocks 120x, 120y can be easily replaced with other weighted blocks of suitable weight according to practical applications. Therefore, the mass of the actuator can be increased by adding the weight of the weighted blocks (and the clamp member, if applicable) to decrease the vibration speed as the actuator operates, and in turn reduce noises generated due to vibrations.

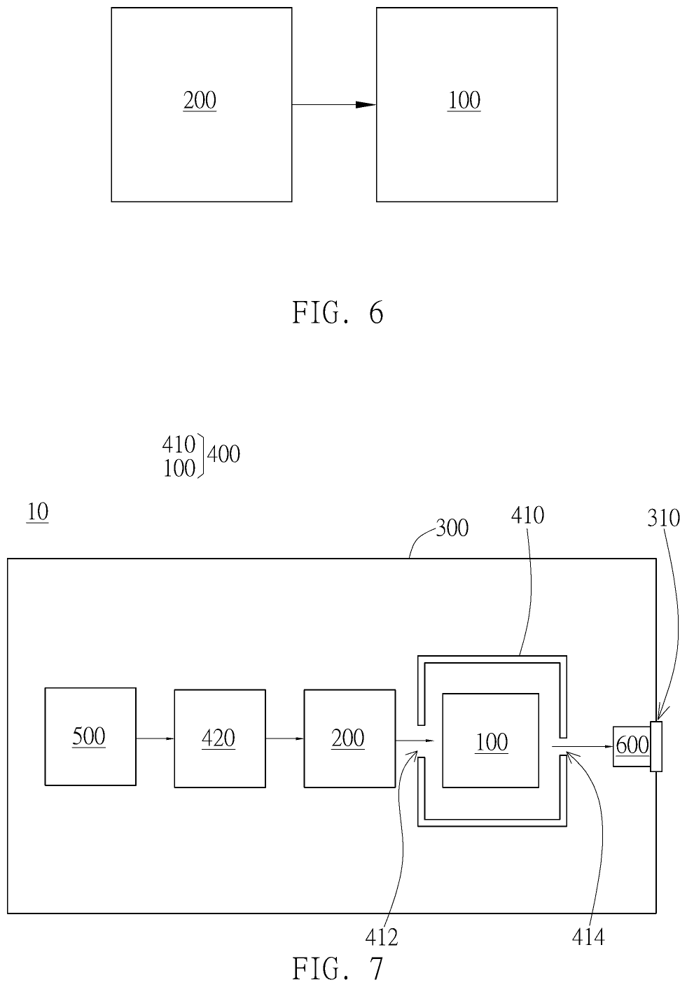

As shown in FIG. 6, in another embodiment, the projector of the invention includes an image-forming component 200 and the actuator module 100. The image-forming component 200 is configured to generate a first image light, and the actuator module 100 can have a structure shown the embodiment of FIG. 2 or FIG. 5A. The actuator module 100 is disposed corresponding to the image-forming component 200 and configured to guide the first image light to a first location or a second location to form a second image light.

Specifically, the image-forming component 200 may include a digital micromirror device (DMD), which is constructed by a plurality of micromirrors configured to selectively reflect light into an image light according to an image signal. The actuator module 100 is disposed in the optical path of the light reflected from the image-forming component 200. The actuator 110 controls the inclined angle of the lens 114 with respect to the frame 112, such as the first inclined angle or the second inclined angle, based on the image signal, so that the first image light is guided to the first location or the second location to form the second image light.

As shown in FIG. 7, in another embodiment, the projector 10 of the invention includes a projector housing 300, the image-forming component 200, an optical engine housing 410, a light modulation unit 420, the actuator module 100, and a light source 500. The projector housing 300 has a first light outlet 310. The light source 500, the light modulation unit 420, and the optical engine housing 410 are disposed inside the projector housing 300. The optical engine housing 410 has a second light outlet 414 and a light inlet 412. The actuator module 100 is disposed inside the optical engine housing 410. In this embodiment, the actuator module 100 may have a structure similar to the embodiment of FIG. 2 including the actuator 110 and the weighted blocks, such as 120x, 120y or a structure similar to the embodiment of FIG. 5A including the actuator 110, the weighted blocks, such as 120x, 120y, and the clamp member 130, so as to reduce noises by decreasing the vibration speed of the actuator in operation through the increased mass of the actuator by the weight of the weighted blocks (and the clamp member). For example, as shown in FIG. 2 or FIG. 5A, the actuator 110 includes the frame 112 and the lens 114, which is movably deposed on the frame 112. The weighted blocks, such as 120x, 120y, can be adhered to the frame 112 or held by the clamp member 130 and located at two opposite sides of the lens 114. The structure detail and the connection of the actuator 110, the weighted blocks 120x, 120y, and the clamp member 130 can be referred to the related descriptions of the previous embodiments and not elaborated again. Moreover, in this embodiment, the actuator module (e.g. the actuator module 100 of FIG. 2 or FIG. 5A) can be integrated to the optical engine housing 410 in a modular form, such as an optical engine module 400. In other words, the actuator 110, the weighted blocks 120x, 120y, and the clamp member 130 (if exists) can be disposed inside the optical engine housing 410 to form the optical engine module 400. The projector housing 300 is configured to accommodate functional elements of the projector 10, such as the light source 500, the image-forming component 200, the optical engine module 400, projector lens and other optical elements, such as lens, reflective mirror, to achieve a desired optical performance.

The light source 500 is disposed inside the projector housing 300 and configured to generate a first light incident to the light modulation unit 420 and reflected by the image-forming component 200 to form the first image light. The first image light enters the optical engine housing 410 from the light inlet 412 and is guided by the actuator 110 to the first location or the second location to form the second image light. The second image light exits the optical engine housing 410 from the second light outlet 414 and emits out of the projector housing 300 from the first light outlet 310. The projector 10 further includes a lens 600 disposed at the first light outlet 310 corresponding to the optical engine module 400 to project the second image light out of the projector housing 300 on a screen or a wall to form an image.

Specifically, in an embodiment, the light source 500 may include a plurality of light-emitting elements. In this embodiment, the light-emitting elements are preferably light-emitting diodes (or laser diodes), which respectively emit red, green, and blue lights, but not limited thereto. In another embodiment, the light-emitting elements may be light-emitting diodes (or laser diodes), which emit white light or light of other colors (or wavelengths). The light source 500 is preferably disposed corresponding to the light modulation unit 420.

In an embodiment, the light modulation unit 420 is embodied as a color wheel and configured to modulate the color of light. The color wheel may include color-changing regions, which are covered with color-changing materials, to generate a light of corresponding color, such as red light, green light, or blue light. In an embodiment, the color-changing material may include materials, which are excited by the light source to generate the light of corresponding color, such as phosphor powders, quantum dots, but not limited thereto. The shape, number, size, and arrangement of the color-changing regions can be modified according to practical applications. The color wheel is driven to rotate according to the image signal, so that the color-changing regions, corresponding to the light emitted from the light source, changes the color of light to achieve a beam-splitting effect. The light modulated by the light modulation unit 420 is incident to the image-forming component 200, so that the first image light is generated by the image-forming component 200.

The image-forming component 200 may include a digital micromirror device (DMD), which is constructed by a plurality of micromirrors and selectively reflects light, which is modulated by the light modulation unit 420, into the first image light according to the image signal. The first image light is incident to the actuator 110, and the actuator 110 selectively guides a pixel light to different locations, such as the four locations A, B, C, and D in FIG. 3D, so that the resolution of the projector can be promoted without increasing the number of micromirrors of the image-forming component 200. For example, in a single dimension, such as X axis or Y axis, the resolution can be increased by two times, or in two dimensions, such as both X axis and Y axis, the resolution can be increased by two times in each dimension, facilitating the 4K ultra high definition (4K UHD) projection applications, but limited thereto.

In the above embodiment, the image-forming component 200 and the light modulation unit 420 are disposed outside the optical engine housing 410 of the optical engine module 400, but not limited thereto. According to practical applications, the image-forming component 200 and the light modulation unit 420 can be integrated to the optical engine module. That is, in another embodiment, the optical engine module may further include the image-forming component 200 and the light modulation unit 420, which are disposed inside the optical engine housing 410.

Although the preferred embodiments of the present invention have been described herein, the above description is merely illustrative. The preferred embodiments disclosed will not limit the scope of the present invention. Further modification of the invention herein disclosed will occur to those skilled in the respective arts and all such modifications are deemed to be within the scope of the invention as defined by the appended claims.

What is claimed is:

1. An actuator module for a projector, comprising:
an actuator including a frame and a lens movably disposed on the frame; and
a pair of weighted blocks disposed on the frame and located at two opposite sides of the lens.

2. The actuator module of claim 1, further comprising a clamp member engaging with the frame to sandwich the pair of weighted blocks between the clamp member and the frame.

3. The actuator module of claim 2, wherein the clamp member has a pressing portion corresponding to the pair of weighted blocks and extending toward the frame to press the pair of weighted blocks against the frame.

4. The actuator module of claim 1, wherein the pair of weighted blocks are adhered to the frame.

5. The actuator module of claim 1, wherein the weight of the pair of weighted blocks is 7.5% to 15% of the weight of the actuator.

6. The actuator module of claim 1, wherein the frame includes a frame body and a lens carrier partially connected to the frame body; the lens is disposed on the lens carrier.

7. The actuator module of claim 6, wherein the lens carrier includes an outer frame and an inner frame; the outer frame is partially connected to the frame body at two sides along a first direction; the inner frame is disposed at an inner side of the outer frame and partially connected to the outer frame at two sides along a second direction perpendicular to the first direction; the lens is disposed on the inner frame.

8. The actuator module of claim 7, wherein the inner frame is movable to change an inclined angle of the lens with respect to the frame body.

9. A projector, comprising:
an image-forming component configured to generate a first image light; and
the actuator module of claim 1, the actuator module disposed corresponding to the image-forming component and configured to guide the first image light to a first location or a second location to form a second image light.

10. The projector of claim 9, wherein the lens is movable relative to the frame to have a first inclined angle or a second inclined angle with respect to the frame, so as to guide the first image light to the first location or the second location.

11. The projector of claim 10, wherein the frame includes a frame body and a lens carrier partially connected to the frame body; the lens is disposed on the lens carrier.

12. The projector of claim 11, wherein the lens carrier includes an outer frame and an inner frame; the outer frame is partially connected to the frame body at two sides along a first direction; the inner frame is disposed at an inner side of the outer frame and partially connected to the outer frame at two sides along a second direction perpendicular to the first direction; the lens is disposed on the inner frame.

13. The projector of claim 12, wherein the inner frame is movable to change an inclined angle of the lens with respect to the frame body to be the first inclined angle or the second inclined angle.

14. A projector, comprising:
a projector housing having a first light outlet;
an image-forming component disposed in the projector housing;
an optical engine housing disposed in the projector housing, the optical engine housing having a second light outlet and a light inlet;
a light modulation unit disposed in the projector housing;
an actuator disposed in the optical engine housing, the actuator comprising a frame and a lens movably disposed on the frame;
a pair of weighted blocks disposed on the frame and located at two opposite sides of the lens; and
a light source disposed in the projector housing and configured to generate a first light incident to the light modulation unit and reflected by the image-forming component to form a first image light, wherein the first image light enters the optical engine housing from the light inlet to form a second image light by the actuator, and the second image light exits the optical engine housing from the second light outlet and emits out of the projector housing from the first light outlet.

15. The projector of claim 14, further comprising a clamp member engaging with the frame to sandwich the pair of weighted blocks between the clamp member and the frame.

16. The projector of claim 15, wherein the clamp member has a pressing portion corresponding to the pair of weighted blocks and extending toward the frame to press the pair of weighted blocks against the frame.

17. The projector of claim 14, wherein the actuator is disposed corresponding to the image-forming component to selectively guide the first image light to a first location or a second location to form the second image light.

18. The projector of claim 14, wherein the frame includes a frame body and a lens carrier partially connected to the frame body; the lens is disposed on the lens carrier.

19. The projector of claim 18, wherein the lens carrier includes an outer frame and an inner frame; the outer frame is partially connected to the frame body at two sides along a first direction; the inner frame is disposed at an inner side of the outer frame and partially connected to the outer frame at two sides along a second direction perpendicular to the first direction; the lens is disposed on the inner frame.

20. The projector of claim 19, wherein the inner frame is movable to change an inclined angle of the lens with respect to the frame body, so that the lens selectively guides the first image light to different locations as the second image light.
